(19) United States
(12) Patent Application Publication
(10) Pub. No.: US 2014/0266735 A1
(43) Pub. Date: Sep. 18, 2014

(54) WIRELESS DIAPER ALARM SYSTEM

(71) Applicants: Nicolas A. Riggio, Miami, FL (US); Paulo Zottolo, Miami, FL (US); Roger Roisen, Minnetrista, MN (US); Michael Mchugh, Plymouth, MN (US)

(72) Inventors: Nicolas A. Riggio, Miami, FL (US); Paulo Zottolo, Miami, FL (US); Roger Roisen, Minnetrista, MN (US); Michael Mchugh, Plymouth, MN (US)

(21) Appl. No.: 14/209,547

(22) Filed: Mar. 13, 2014

Related U.S. Application Data
(60) Provisional application No. 61/784,534, filed on Mar. 14, 2013.

(51) Int. Cl. G08B 21/02

(52) U.S. Cl. CPC G08B 21/0205
USPC 340/573.5

(57) ABSTRACT

A system includes a flexible substrate to couple to a medium. A sensor is supported by the substrate. A microcontroller is supported by the substrate and coupled to the sensor to drive the sensor and receive signals from the sensor representative of wetness of the medium. An RF transmitter is supported by the substrate and coupled to the microcontroller and transmit signals representative of wetness of the medium.

### RELATED APPLICATION

This application claims priority to U.S. Provisional Application Ser. No. 61/784,534 (entitled WIRELESS DIAPER ALARM SYSTEM, filed Mar. 14, 2013) which is incorporated herein by reference.

### BACKGROUND

Detection and alerting of micturition has been performed for bed wetting and diaper soiling. Prior systems use moisture detection mats placed under sheets on top of a mattress, or inside a diaper to detect micturition, measuring temperature or resistivity changes due to micturition. Such mats can be costly, and are usually physically coupled circuitry to provide an alarm.

A sensor and alarm for wetness condition of a diaper is helpful to a caregiver, as it relieves the caregiver of having to constantly check on the condition of the diaper. The sensor and alarm can quickly alert the caregiver, allowing quick replacement of the diaper and avoidance of diaper rash.

### SUMMARY

A system includes a capacitive sensor, a microcontroller coupled to the capacitive sensor to drive the capacitive sensor and receive signals from the capacitive sensor representative of micturition, and an RF transmitter coupled to the microcontroller and transmit signals representative of micturition.

In a further embodiment, a system includes a flexible substrate to couple to a medium. A sensor is supported by the substrate. A microcontroller is supported by the substrate and coupled to the sensor to drive the sensor and receive signals from the sensor representative of wetness of the medium. An RF transmitter is supported by the substrate and coupled to the microcontroller and transmit signals representative of wetness of the medium.

A method includes sensing wetness in a diaper via an adhesive patch containing a sensor, controller, and transmitter, transmitting a signal via the transmitter to a mobile device via a Bluetooth connection, and causing display of an indication of the diaper being wet on the mobile device.

### BRIEF DESCRIPTION OF THE DRAWINGS

FIG. 1 is a block diagram of a sensing patch for detecting micturition according to an example embodiment.

FIG. 2 is a block diagram illustrating use of a sensing patch on a diaper to communicate with a mobile device according to an example embodiment.

FIG. 3 is a schematic diagram illustrating a capacitive sensor driven by a micro controller according to an example embodiment.

FIG. 4 is a block diagram of a processing system for performing one or more methods according to an example embodiment.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

The functions or algorithms described herein may be implemented in software or a combination of software and human implemented procedures in one embodiment. The software may consist of computer executable instructions stored on computer readable media such as memory or other type of storage devices. Further, such functions correspond to modules, which are software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system.

FIG. 1 is a block diagram of a sensing patch 100 for detecting micturition according to an example embodiment. The sensing patch 100 may include an adhesive, and may be formed of a flexible circuit board in one embodiment. A sensor 110 is supported on the patch 100 and is coupled to a controller 115, such as a simple, low cost, microcontroller. The controller 115 receives signals from the sensor 110 representative of a sensed wetness, such as may be caused by micturition, commonly referred to as urination. In further embodiments, any type of wetness may be sensed.

The controller 115 drives a transmitter 120 and causes the transmitter to transmit signals representative of the sensed wetness. In one embodiment, the transmitter 120 is a low cost transmitter such as may be commonly used in a wireless key fob. The transmitter 120 may transmit signals in accordance with one or more low power standards, including, but not limited to BTLE 4.0 stack, IEEE 802.15.1, or IEEE 802.15.4. In one embodiment, the signals are compatible with Bluetooth receivers, such as are commonly found in smart phones and other portable electronic devices.

In one embodiment, the patch 100 is formed with adhesive on the same side of the patch as the sensor, allowing the sensor to be placed in contact with a diaper 205 as illustrated in FIG. 2. When the diaper becomes wet, the sensor 110 provides a signal representative of a change of a parameter caused by the wetness. Several different types of sensors may be used, such as resistive sensor having a resistance that changes with direct contact with a liquid, a temperature sensor that detects an increase in temperature associated with micturition, or a capacitive sensor that need not be in direct contact with the wetness, allowing it to be placed on an outside of a diaper.

When the transmitter transmits signals, a mobile device 210 may be used to receive an alarm indicative of micturition. Such a mobile device may be a cell phone in some embodiments, with the alarm taking the form of a text message, or an app that provides an interface to a user for notifying a user of the micturition, as well as many other types of events.

FIG. 3 is a schematic diagram illustrating an example capacitive sensing system 400. A controller 410 provides a control signal to an amplifier 415, such as an operation amplifier, that causes it to provide an oscillating output signal to a capacitor 420. The capacitor 420 includes a first plate 425 corresponding to the medium to which the patch 100 is coupled, such as a diaper in one embodiment. A second capacitor plate 430 completes the capacitor and forms a feedback loop 435 between an output of the amplifier 415 and an input of the amplifier 415. The output of the amplifier is provided via a conductor 440 to controller 410. The oscillating output of the amplifier is shown at 450, and increases when the medium becomes wet due to a corresponding change in the dielectric constant of the medium. When the medium becomes wet, the dielectric constant increases, causing the output frequency to also increase. The controller detects the increase and provides a signal indicative of the medium becoming wet. The use of a capacitive sensor as described allows sensing of wetness away from a body, and even through a liquid barrier of a diaper.

FIG. 4 is a block diagram of a computing device, according to an example embodiment. In one embodiment, multiple such computer systems are utilized in a distributed network to implement multiple components in a transaction based environment. An object-oriented, service-oriented, or other architecture may be used to implement such functions and communicate between the multiple systems and components. One example computing device in the form of a computer 410, may include a processing unit 402, memory 404, removable storage 412, and non-removable storage 414. Memory 404 may include volatile memory 406 and non-volatile memory 408. Computer 410 may include—or have access to a computing environment that includes—a variety of computer-readable media, such as volatile memory 406 and non-volatile memory 408, removable storage 412 and non-removable storage 414. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions. Computer 410 may include or have access to a computing environment that includes input 416, output 418, and a communication connection 420. The computer may operate in a networked environment using a communication connection to connect to one or more remote computers, such as database servers. The remote computer may include a personal computer (PC), server, router, network PC, a peer device or other common network node, or the like. The communication connection may include a Local Area Network (LAN), a Wide Area Network (WAN) or other networks.

Computer-readable instructions stored on a computer-readable medium are executable by the processing unit 402 of the computer 410. A hard drive, CD-ROM, and RAM are some examples of articles including a non-transitory computer-readable medium. For example, a computer program 425 capable of providing a generic technique to perform access control check for data access and/or for doing an operation on one of the servers in a component object model (COM) based system according to the teachings of the present invention may be included on a CD-ROM and loaded from the CD-ROM to a hard drive. The computer-readable instructions allow computer 410 to provide generic access controls in a COM based computer network system having multiple users and servers.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. A system comprising:
a capacitive sensor;
a microcontroller coupled to the capacitive sensor to drive the capacitive sensor and receive signals from the capacitive sensor representative of micturition; and
an RF transmitter coupled to the microcontroller and transmit signals representative of micturition.

2. The system of claim 1 wherein the RF transmitter transmits signals based on a BTLE 4.0 stack, IEEE 802.15.1 standard, or IEEE 802.15.4 standard.

3. The system of claim 1 wherein the transmitted signals are transmitted to a mobile device.

4. The system of claim 3 and further comprising a mobile device to receive the transmitted signals via a Bluetooth connection to the RF transmitter.

5. The system of claim 1 wherein the capacitive sensor comprises a capacitor plate coupled to an amplifier in a feedback loop.

6. The system of claim 1 wherein the capacitor plate is adapted to be positioned proximate a medium to be sensed.

7. The system of claim 6 wherein the medium to be sensed has a dielectric constant that changes with wetness of the medium.

8. The system of claim 1 and further comprising a substrate to support the sensor, controller and RF transmitter.

9. The system of claim 9 wherein the substrate further comprises an adhesive to couple the capacitor plate to a medium to be sensed.

10. A system comprising:
a flexible substrate to couple to a medium;
a sensor supported by the substrate;
a microcontroller supported by the substrate and coupled to the sensor to drive the sensor and receive signals from the sensor representative of wetness of the medium; and
an RF transmitter supported by the substrate and coupled to the microcontroller and transmit signals representative of wetness of the medium.

11. The system of claim 10 wherein the sensor comprises a capacitive sensor.

12. The system of claim 11 wherein the capacitive sensor comprises a capacitor plate coupled to an amplifier in a feedback loop.

13. The system of claim 12 wherein the capacitor plate is adapted to be positioned proximate a medium to be sensed.

14. The system of claim 13 wherein the medium to be sensed has a dielectric constant that changes with wetness of the medium.

15. The system of claim 10 wherein the sensor comprises a resistive sensor or a temperature sensor.

16. The system of claim 10 wherein the substrate further comprises an adhesive to couple the capacitor plate to a medium to be sensed.

17. A method comprising:
sensing wetness in a diaper via an adhesive patch containing a sensor, controller, and transmitter;
transmitting a signal via the transmitter to a mobile device via a Bluetooth connection; and
causing display of an indication of the diaper being wet on the mobile device.

18. The method of claim 17 wherein the RF transmitter transmits signals based on a BTLE 4.0 stack, IEEE 802.15.1 standard, or IEEE 802.15.4 standard.

19. The method of claim 17 wherein the transmitted signals are transmitted to a mobile device.

20. The method of claim 19 and further comprising a mobile device to receive the transmitted signals via a Bluetooth connection to the RF transmitter.

21. The method of claim 17 wherein the capacitive sensor comprises a capacitor plate coupled to an amplifier in a feedback loop.

22. The method of claim 17 wherein the capacitor plate is adapted to be positioned proximate a medium to be sensed.

23. The method of claim 22 wherein the medium to be sensed has a dielectric constant that changes with wetness of the medium.

24. The method of claim 17 and further comprising a substrate to support the sensor, controller and RF transmitter.

25. The method of claim 24 wherein the substrate further comprises an adhesive to couple the capacitor plate to a medium to be sensed.
